(19) United States
(12) Patent Application Publication
(10) Pub. No.: US 2026/0260265 A1
(43) Pub. Date: Sep. 3, 2026

(54) System for Targeted Political Outreach Utilizing Data Clustering Techniques and Generative Artificial Intelligence

(71) Applicant: Gary Kremen, Menlo Park, CA (US)

(72) Inventor: Gary Kremen, Menlo Park, CA (US)

(21) Appl. No.: 19/530,161

(22) Filed: Feb. 4, 2026

Related U.S. Application Data
(60) Provisional application No. 63/754,375, filed on Feb. 5, 2025.

(51) Int. Cl. G06Q 30/0251; G06F 18/23; G06Q 50/26

(52) U.S. Cl. CPC G06Q 30/0251; G06F 18/23; G06Q 50/26

(57) ABSTRACT

A system and method for improving the efficiency and effectiveness of political outreach by optionally augmenting and/or reducing a voter file coupled with data clustering techniques and generative artificial intelligence to create and deliver targeted political messages to distinct voter groups. This system reduces the time and cost associated with political outreach while increasing the accuracy and relevance of the messages.

### CROSS-REFERENCE TO RELATED APPLICATIONS

This application claims the benefit of priority to co-owned and co-pending U.S. Provisional Patent Application Ser. No. 63/754,375 filed Feb. 5, 2025, of the same title, the contents of which being incorporated herein by reference in its entirety.

### FIELD

The present disclosure relates generally to the field of political outreach, and more particularly, and in one exemplary aspect, to systems and methods for utilizing data clustering techniques and generative artificial intelligence for generating effective and targeted political outreach messaging.

### BACKGROUND

Many political campaigns, especially down-ballot or local races, operate with limited budgets and small teams. Campaign staff and consultants are often trained in political science, communications, or public relations and often group voters into broad categories based on available demographic and geographic data, like age, gender, party affiliation, and propensity to vote. This is done in part because these broad groups are easier to identify and use by political campaigns. Additionally, campaigns frequently prioritize traditional approaches and are oftentimes hesitant to adopt newer more effective techniques for fear of disrupting established workflows or of obtaining uncertain results from their efforts. However, with recent technological developments that assist with, for example, the gathering of large amounts of online data, new techniques are needed that leverage the ability to gather relevant information about the voting public and target effective messaging towards these voters.

### SUMMARY

The present disclosure satisfies the foregoing needs by providing, inter alia, methods, apparatus and systems for the generation of targeted political outreach messaging using data clustering techniques and generative artificial intelligence algorithms.

In one aspect, a computer-implemented method for creating and transmitting targeted outreach messaging is disclosed. In one embodiment, the method includes receiving characterizing data associated with a plurality of individuals from one or more data stores; normalizing the characterizing data into feature vectors in an n-dimensional feature space; applying at least one clustering algorithm to the feature vectors to generate a plurality of clusters, each cluster comprising feature vectors for a subset of the plurality of individuals; for each of the plurality of clusters, computing a cluster metadata object comprising one or more aggregated statistics derived from the characterizing data of individuals in the cluster; for each of the plurality of clusters, generating a generative-artificial-intelligence (AI) input structure by inserting at least a portion of the corresponding cluster metadata object and campaign context data into a generative-AI prompt template, wherein the generative-AI input structure further comprises a tone parameter and a variability parameter; providing the generative-AI input structure to a generative AI model to obtain at least one outreach message for the corresponding cluster; for each of the plurality of individuals, selecting at least one communication channel based on a reachability vector associated with that individual; and transmitting, via one or more outreach channel adapters configured for the selected communication channel or channels, the outreach messages to the individuals associated with the corresponding clusters.

In one variant, the applying of the at least one clustering algorithm comprises applying an unsupervised clustering algorithm selected from the group consisting of K-means clustering, MiniBatchKMeans clustering, density-based spatial clustering of applications with noise (DBSCAN), and agglomerative hierarchical clustering.

In another variant, the computing of the cluster metadata object comprises computing, for each cluster, one or more of: counts or percentages for categorical attributes, means or medians for numerical attributes, dispersion or concentration metrics, entropy measures, divergence measures relative to a reference population, and derived attributes including at least one of a primary language, a dominant issue category, a dominant outreach channel, or a dominant demographic characteristic.

In yet another variant, the tone parameter is derived from a user interface control and is mapped to one or more model control values including at least one of: a textual style identifier, a target reading level, a constraint on message length, or a constraint on directness of the outreach message.

In yet another variant, the variability parameter is mapped to one or more stochastic generation controls of the generative AI model and further controls a diversification process that: generates a plurality of candidate outreach messages for the corresponding cluster; computes similarity scores between representations of the plurality of candidate outreach messages; and selects a subset of the plurality of candidate outreach messages whose pairwise similarity scores satisfy a minimum dissimilarity threshold that depends on the variability parameter.

In yet another variant, the method includes for each combination of a cluster, a candidate outreach message, and a communication channel, constructing a feature vector comprising at least a subset of fields from the cluster metadata object, one or more campaign attributes, one or more communication-channel attributes, and one or more message attributes; and providing the feature vector to a supervised predictive scoring model configured to output a predicted engagement metric for the combination; wherein transmitting the outreach messages comprises selecting, based at least in part on the predicted engagement metrics, one or more combinations of clusters, outreach messages, and communication channels whose predicted engagement metrics satisfy a selection criterion.

In yet another variant, the cluster metadata object comprises language-related attributes and the method further comprises: selecting, for at least one of the clusters, a target language based on the language-related attributes; and generating the outreach message or messages for the at least one of the clusters in the target language by including an indication of the target language in the generative-AI input structure.

In yet another variant, the method further includes for at least one of the clusters: providing the cluster metadata object and campaign context data to a generative image or video model to generate image or video content conditioned on the cluster metadata object; and transmitting the generated image or video content, together with the outreach message or messages, via one or more outreach channel adapters configured to deliver visual content.

In yet another variant, the plurality of individuals comprise registered voters and the characterizing data comprise a voter file obtained from a governmental agency, and wherein the outreach messages comprise political campaign messages relating to at least one of candidates for elected office or ballot measures.

In yet another variant, the method includes augmenting the characterizing data with derived attributes and additional outreach identifiers and excluding individuals from the plurality of individuals based on reachability vectors or campaign criteria prior to applying the at least one clustering algorithm.

In another embodiment, the computer-implemented method for generating and transmitting targeted political campaign messages to registered voters includes: receiving, from at least one government-maintained voter-registration data store, characterizing data associated with a plurality of registered voters, the characterizing data comprising at least a name, a residential address, a voting-history indicator, and a party-affiliation indicator for each registered voter; optionally augmenting the characterizing data with one or more derived attributes and outreach identifiers, the derived attributes comprising at least one of a propensity-to-vote score or a political-leaning score and the outreach identifiers comprising at least one of an electronic mail address, a telephone number, or a connected-television identifier; normalizing the characterizing data, including any derived attributes and outreach identifiers, into feature vectors in an n-dimensional feature space; applying at least one unsupervised clustering algorithm to the feature vectors to generate a plurality of clusters, each cluster comprising feature vectors corresponding to a subset of the registered voters; computing, for each of the plurality of clusters, a cluster metadata object comprising one or more aggregated statistics derived from the characterizing data of the registered voters in the cluster, the aggregated statistics including at least a distribution over party-affiliation indicators and a distribution over the voting-history indicators; generating, for each of the plurality of clusters, a generative-artificial-intelligence (AI) input structure by inserting at least a portion of the corresponding cluster metadata object and political campaign context data identifying at least one candidate for elected office or ballot measure into a generative-AI prompt template, wherein the generative-AI input structure further comprises a tone parameter and a variability parameter; providing the generative-AI input structure to a generative AI model to obtain a plurality of political campaign outreach messages for the corresponding cluster; for each of the plurality of registered voters, selecting at least one of the plurality of political campaign outreach messages and at least one communication channel based on a reachability vector associated with that registered voter; and transmitting, via one or more outreach channel adapters configured for the selected communication channel or channels, the selected political campaign outreach messages to the registered voters associated with the corresponding clusters.

In yet another variant, the method includes 20. The method of claim 1, further comprising: constructing, for at least one of the plurality of clusters, an extended campaign context object that combines the cluster metadata object with one or more position descriptors associated with at least one candidate, ballot measure, or other political or issue-based proposition; inserting the extended campaign context object into the generative-AI prompt template as at least a portion of the campaign context data; and providing at least one outreach message generated from the extended campaign context object as an intermediate representation to one or more downstream pipeline-processing modules configured to perform at least one of: rewriting the outreach message, adapting the outreach message for a particular communication channel, or scoring or classifying the outreach message prior to transmission.

In another aspect, a non-transitory computer-readable medium is disclosed. In one embodiment, the non-transitory computer-readable medium stores instructions that, when executed by one or more processors, cause the one or more processors to perform any one or more of the aforementioned methods.

In another embodiment, the non-transitory computer-readable medium stores instructions that, when executed by one or more processors, cause the one or more processors to perform a method comprising: receiving, from at least one government-maintained voter-registration data store, characterizing data associated with a plurality of registered voters, the characterizing data comprising at least a name, a residential address, a voting-history indicator, and a party-affiliation indicator for each registered voter; optionally augmenting the characterizing data with one or more derived attributes and outreach identifiers, the derived attributes comprising at least one of a propensity-to-vote score or a political-leaning score and the outreach identifiers comprising at least one of an electronic mail address, a telephone number, or a connected-television identifier; normalizing the characterizing data, including any derived attributes and outreach identifiers, into feature vectors in an n-dimensional feature space; applying at least one unsupervised clustering algorithm to the feature vectors to generate a plurality of clusters, each cluster comprising feature vectors corresponding to a subset of the registered voters; computing, for each of the plurality of clusters, a cluster metadata object comprising one or more aggregated statistics derived from the characterizing data of the registered voters in the cluster; generating, for each of the plurality of clusters, a generative-artificial-intelligence (AI) input structure by inserting at least a portion of the corresponding cluster metadata object and political campaign context data identifying at least one candidate for elected office or ballot measure into a generative-AI prompt template, wherein the generative-AI input structure further comprises a tone parameter and a variability parameter; providing the generative-AI input structure to a generative AI model to obtain a plurality of political campaign outreach messages for the corresponding cluster; for each of the plurality of registered voters, selecting at least one of the plurality of political campaign outreach messages and at least one communication channel based on a reachability vector associated with that registered voter; and transmitting, via one or more outreach channel adapters configured for the selected communication channel or channels, the selected political campaign outreach messages to the registered voters associated with the corresponding clusters.

In yet another aspect, a system for creating and transmitting targeted outreach messaging is disclosed. In one embodiment, the system includes one or more processors and a non-transitory computer-readable medium storing instructions that, when executed by the one or more processors, cause the system to: receive characterizing data associated with a plurality of individuals from one or more data stores; normalize the characterizing data into feature vectors in an n-dimensional feature space; apply at least one clustering algorithm to the feature vectors to generate a plurality of clusters, each cluster comprising feature vectors for a subset of the plurality of individuals; compute, for each of the plurality of clusters, a cluster metadata object comprising one or more aggregated statistics derived from the characterizing data of individuals in the cluster; generate, for each of the plurality of clusters, a generative-AI input structure by inserting at least a portion of the corresponding cluster metadata object and campaign context data into a generative-AI prompt template, wherein the generative-AI input structure further comprises a tone parameter and a variability parameter; provide the generative-AI input structure to a generative AI model to obtain at least one outreach message for the corresponding cluster; select, for each of the plurality of individuals, at least one communication channel based on a reachability vector associated with that individual; and transmit, via one or more outreach channel adapters configured for the selected communication channel or channels, the outreach messages to the individuals associated with the corresponding clusters.

In one variant, the at least one clustering algorithm comprises an unsupervised clustering algorithm selected from the group consisting of K-means clustering, MiniBatchKMeans clustering, density-based spatial clustering of applications with noise (DBSCAN), and agglomerative hierarchical clustering.

In another variant, a predictive scoring module implemented by the one or more processors is configured to: construct, for each combination of a cluster, a candidate outreach message, and a communication channel, a feature vector comprising at least a subset of fields from the cluster metadata object, one or more campaign attributes, one or more communication-channel attributes, and one or more message attributes; and provide the feature vector to a supervised predictive scoring model configured to output a predicted engagement metric for the combination; wherein the instructions further cause the system to select, based at least in part on the predicted engagement metrics, one or more combinations of clusters, outreach messages, and communication channels for transmission.

In yet another variant, the cluster metadata object comprises language-related attributes and the instructions further cause the system to: select a target language for at least one of the clusters based on the language-related attributes; and generate the outreach message or messages for the at least one of the clusters in the target language and optionally generate associated image or video content conditioned on the cluster metadata object.

In yet another variant, the plurality of individuals comprise registered voters and the characterizing data comprise a voter file obtained from a governmental agency, and wherein the outreach messages comprise political campaign messages relating to at least one of candidates for elected office or ballot measures.

In yet another variant, the instructions further cause the system to: construct, for at least one of the plurality of clusters, an extended campaign context object that combines the cluster metadata object with one or more position descriptors associated with at least one candidate, ballot measure, or other political or issue-based proposition; insert the extended campaign context object into the generative-AI prompt template as at least a portion of the campaign context data; and provide at least one outreach message generated from the extended campaign context object as an intermediate representation to one or more downstream pipeline-processing modules configured to perform at least one of: rewriting the outreach message, adapting the outreach message for a particular communication channel, or scoring or classifying the outreach message prior to transmission.

In another embodiment, the system for generating and transmitting targeted political campaign messages to registered voters, comprising: one or more processors; and a non-transitory computer-readable medium storing instructions that, when executed by the one or more processors, cause the system to: receive, from at least one government-maintained voter-registration data store, characterizing data associated with a plurality of registered voters, the characterizing data comprising at least a name, a residential address, a voting-history indicator, and a party-affiliation indicator for each registered voter; normalize the characterizing data into feature vectors in an n-dimensional feature space; apply at least one unsupervised clustering algorithm to the feature vectors to generate a plurality of clusters, each cluster comprising feature vectors corresponding to a subset of the registered voters; compute, for each of the plurality of clusters, a cluster metadata object comprising one or more aggregated statistics derived from the characterizing data of the registered voters in the cluster; generate, for each of the plurality of clusters, a generative-AI input structure by inserting at least a portion of the corresponding cluster metadata object and political campaign context data identifying at least one candidate for elected office or ballot measure into a generative-AI prompt template, wherein the generative-AI input structure further comprises a tone parameter and a variability parameter; provide the generative-AI input structure to a generative AI model to obtain a plurality of political campaign outreach messages for the corresponding cluster; select, for each of the plurality of registered voters, at least one political campaign outreach message and at least one communication channel based on a reachability vector associated with that registered voter; and transmit, via one or more outreach channel adapters configured for the selected communication channel or channels, the selected political campaign outreach messages to the registered voters associated with the corresponding clusters.

Other features and advantages of the present disclosure will immediately be recognized by persons of ordinary skill in the art with reference to the attached drawings and detailed description of exemplary implementations as given below.

### BRIEF DESCRIPTION OF DRAWINGS

The features, objectives, and advantages of the present disclosure will become more apparent from the detailed description set forth below when taken in conjunction with the drawings, wherein:

FIG. 1 is a logical flow diagram of one exemplary method for the application of clustering algorithms to characterizing data and generating and transmitting generative artificial intelligence messages to individuals associated with the characterizing data, in accordance with the principles of the present disclosure.

FIG. 2 is an exemplary graphical user interface (GUI) illustrating exemplary characterizing data contained within a voter file, in accordance with the principles of the present disclosure.

FIG. 3 is an exemplary GUI illustrating an interface for the clustering of received characterizing data, in accordance with the principles of the present disclosure.

FIG. 4 is an exemplary GUI illustrating actual labels or segment targets that are utilized as an input to a generative artificial intelligence (AI) engine, in accordance with the principles of the present disclosure.

FIG. 5 is an exemplary GUI illustrating generative AI messages that are created using the parsed metadata from the created segments, in accordance with the principles of the present disclosure.

FIG. 6 is an exemplary GUI illustrating sample demographics of a candidate or other campaign information, in accordance with the principles of the present disclosure.

FIG. 7A-7N are exemplary GUIs illustrating an exemplary implementation of the methodology of FIG. 1, in accordance with the principles of the present disclosure.

### DETAILED DESCRIPTION

Detailed descriptions of the various embodiments and variants of the apparatus and methods of the present disclosure are now provided. It is noted that wherever practicable similar or like reference numbers may be used in the figures and may indicate similar or like functionality. The figures depict embodiments of a system for targeted political outreach using data clustering and generative artificial intelligence for purposes of illustration only. One skilled in the art will readily recognize from the following description that alternative embodiments of the structures and methods illustrated may be employed without necessarily departing from the principles described herein.

### Definitions

As used herein, the term “characterizing data” refers to machine-readable information associated with an individual or entity that can be represented as a feature vector in an n-dimensional feature space. Characterizing data may include, without limitation, any combination of demographic attributes, behavioral attributes, contact information, derived scores (e.g., propensity to vote, partisanship or issue affinity), and outreach identifiers.

As used herein, the term “cluster” refers to a group of two or more individuals whose feature vectors satisfy a similarity criterion using a clustering algorithm, such as, for example, K-means, MiniBatchKMeans, density-based spatial clustering of applications with noise (DBSCAN), or agglomerative hierarchical clustering.

As used herein, the term “cluster metadata object” refers to a data structure that includes one or more aggregated values or distributions computed from the characterizing data of the individuals in a given cluster. By way of non-limiting example, a cluster metadata object may include, for the members of a cluster, one or more of: (i) counts or percentages for categorical attributes; (ii) means or medians for numerical attributes; (iii) dispersion or concentration metrics; (iv) entropy or divergence measures relative to a reference population; and (v) derived attributes such as a primary language, a dominant issue category, a dominant outreach channel, or a dominant demographic characteristic.

As used herein, the term “reachability vector” refers to a representation, associated with an individual and/or cluster, that indicates which outreach channels (e.g., email, short message service (SMS), telephone, connected television, online display advertising, and/or direct mail) are available for that individual or cluster. The reachability vector may include binary flags or scores for each outreach channel.

As used herein, the term “generative-AI prompt template” refers to a machine-readable template that defines one or more slots or placeholders for cluster metadata, campaign context (e.g., candidate or issue information), tone and variability parameters, channel information, and language information. The template is compiled into a prompt string or other model input structure to be supplied to a generative model.

As used herein, the term “tone parameter” refers to one or more numerical values that control stylistic aspects of generated content, such as, for example, formality, directness, urgency, or emotional intensity. In some implementations, the tone parameter is derived from a user interface control such as a slider and is mapped to one or more model control values, such as, for example, a textual style identifier, a target reading level, or a constraint on message length.

As used herein, the term “variability parameter” refers to one or more numerical values that control the diversity among multiple generated messages associated with the same cluster and campaign context. In some implementations, the variability parameter is mapped to one or more stochastic generation controls (e.g., temperature, nucleus sampling threshold, or beam-search parameters) and may also control an acceptance threshold for determining whether two candidate messages are sufficiently different from one another.

As used herein, the term “predictive scoring model” refers to a supervised machine learning model configured to receive as input a feature vector representing a cluster-channel-message combination and to output a predicted engagement score or other performance metric. The input feature vector may include, without limitation, fields from the cluster metadata object, campaign attributes (e.g., election type, geography, or policy focus), channel attributes, and numerical encodings of message features.

As used herein, the term “outreach channel adapter” refers to a software component or service that is configured to transform generated content and associated addressing information into a format suitable for a particular communication channel and to initiate transmission of the content via that channel.

### Overview

In traditional political outreach, data clustering techniques are not used due to several factors, including resource limitations, lack of expertise, and the fast-paced nature of campaigns. For example, data clustering techniques often require significant computational resources, specialized software, and skilled data analysts. As a result, these resources may be out of reach for campaigns with tight budgets, leading them to rely on simpler, less data-intensive methods for voter targeting. In addition, data clustering requires knowledge of data science, statistics, and machine learning, skills that many traditional political outreach teams lack, making it challenging to implement complex clustering techniques effectively. For data clusters to be effective, campaign teams need to understand how to apply them in a way that drives real-world outreach efforts. Traditional campaigns may struggle to take clusters from an abstract data format and translate them into actionable strategies, like messaging or targeted advertising. Without an integrated approach, the effort to create data clusters might seem impractical or disconnected from outreach activities.

Practitioners in the field of clustering data are familiar with segmenting groups of people based on shared characteristics. However, these traditional methods often result in broad segments that do not fully capture subtle or emerging patterns in voter preferences, which limits the ability to generate truly nuanced and targeted groups for outreach. While clustering experts can group voters, they lack generative AI techniques to develop tailored, outreach-able messaging for each cluster. Effective political outreach requires messaging that resonates on an individual or small-group level, which generative AI can create based on nuanced insights derived from clustered data. Without this, outreach efforts may rely on generic messages that fail to engage voters effectively. Those who specialize in clustering data typically have limited expertise in the practicalities of political outreach. They may understand how to group voters but not how to translate these clusters into actionable strategies or outreach programs that effectively influence or engage the electorate. As a result, clusters remain as analytical outputs without clear applications in real-world campaign efforts.

Additionally, clustering experts often lack the knowledge or tools to integrate generative AI for voter file augmentation (adding relevant, insightful data) or reduction (eliminating irrelevant or outdated data). These capabilities are essential for keeping voter databases accurate and targeted, which is particularly important in down-ballot races where resources are limited. Without AI-driven augmentation or reduction, clusters can become stale or less representative of the current voter landscape. Political outreach practitioners often do not have experience with clustering data or understanding how it could enhance their strategies when coupled with generative AI. As a result, outreach efforts remain largely generalized and may not fully leverage data-driven insights to target voter concerns effectively. Integrating clustering with generative AI bridges this gap, enabling more precise messaging that resonates deeply with specific voter groups. In general, clustering techniques are not utilized in, for example, down-ballot races due to budget constraints, resource limitations, or a lack of expertise. Down-ballot campaigns often focus on broad outreach rather than tailored, data-driven messaging. By incorporating generative AI into clustering processes, campaigns can benefit from more personalized outreach without the heavy costs associated with traditional data analysis. This approach could make clustering and targeted messaging accessible and impactful for local and lower-profile races.

These gaps and limitations demonstrate the need for an advanced solution that integrates clustering technology with generative AI to create unique voter segments, develop tailored messaging, and provide a unified approach to voter file management and outreach strategies. This innovation could transform political outreach by enabling campaigns to engage with voters more personally and effectively, filling critical gaps in current practices. Aspects of the present disclosure relate to political outreach and specifically to political outreach systems that use data clustering and generative AI to create and deliver targeted political messages to voters. Traditional methods of political outreach rely on broad segmentation techniques, which may not effectively target the specific concerns and preferences of individual voter groups. By using data clustering techniques and combining these techniques with generative AI, targeted political outreach becomes more effective at a reduced cost.

In traditional political outreach, segmentation or the “clustering” of data is often treated as an art rather than a science. Campaign strategists group voters based on intuition or basic demographic factors, which can be subjective and limit the accuracy of targeting. The present disclosure integrates data clustering techniques with generative AI, transforming segmentation into a more scientific and data-driven process. This not only improves precision but also allows campaigns to create more tailored, relevant messages for specific voter groups, maximizing engagement and effectiveness. Advanced clustering and segmentation techniques are usually in the domain of academic researchers. Smaller or down-ballot campaigns typically lack the budget, expertise, and data infrastructure required to implement these advanced methods. The present disclosure democratizes this capability, making sophisticated clustering and targeted messaging accessible to campaigns of all sizes. By doing so, it empowers local and smaller campaigns to leverage data-driven outreach that was previously out of reach. Moreover, manually crafting messages for different voter segments is a time-consuming and expensive process, often requiring multiple rounds of drafting, testing, and refining to ensure accuracy. The present disclosure, by using generative AI, automates this process, allowing campaigns to develop customized messages for each voter cluster efficiently. This automation significantly reduces both the time, and the cost associated with message creation, allowing campaign staff to allocate resources more effectively.

Political campaigns also often struggle to deliver highly relevant messages that resonate with individual voters or unique voter groups. The present disclosure addresses this by using data-driven clustering to form accurate, dynamic voter segments and generative AI to create targeted messaging based on these insights. The result is outreach that is far more aligned with voters' specific concerns and preferences, increasing the likelihood of positive engagement and, ultimately, support. Traditional outreach methods can also be costly, particularly when factoring in the expenses associated with extensive data analysis, message development, and manual labor. By automating these processes, the present disclosure offers campaigns a more cost-effective solution. Not only does it reduce the need for specialized personnel to conduct data clustering and message customization, but it also minimizes the risk of overspending on ineffective outreach. Campaigns can reallocate these savings towards other critical campaign needs or invest further in refining and expanding their outreach strategies.

The present disclosure also includes the ability to augment and reduce the voter file as necessary. By augmenting, campaigns can ensure that they have the most relevant and up-to-date information on voters, and by reducing, they can eliminate outdated or irrelevant data that may cloud outreach efforts. This functionality not only increases accuracy but also streamlines data management, allowing campaigns to focus their outreach on voters who are most likely to engage and respond positively. In sum, the present disclosure provides a comprehensive, scalable, and affordable solution that significantly enhances the accuracy, efficiency, and cost-effectiveness of political outreach. By transforming an artful, resource-intensive process into a scientific, streamlined system, it enables campaigns to connect with voters in a meaningful, targeted way—while saving valuable time and money.

### Generalized Methodology

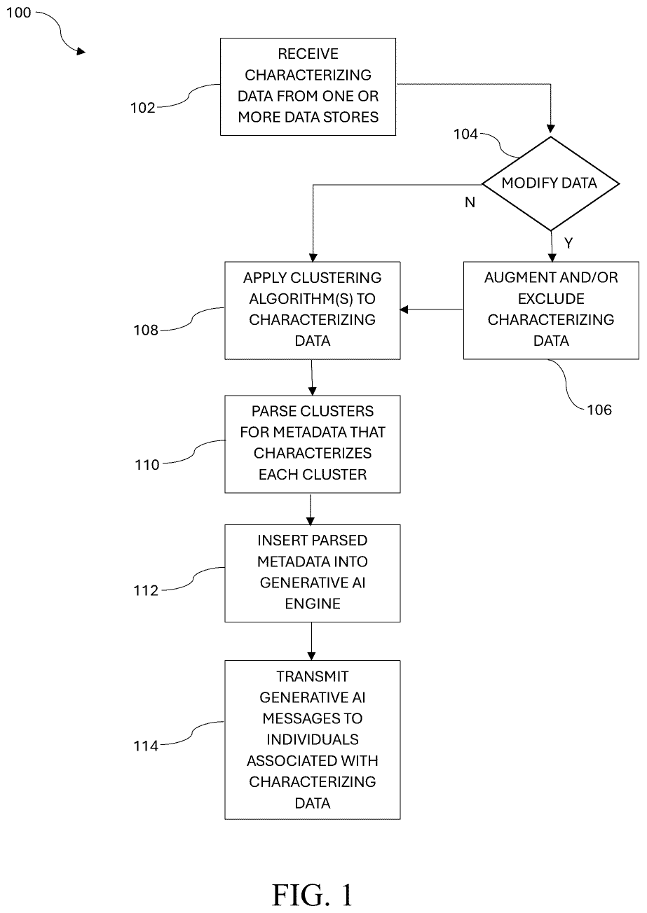

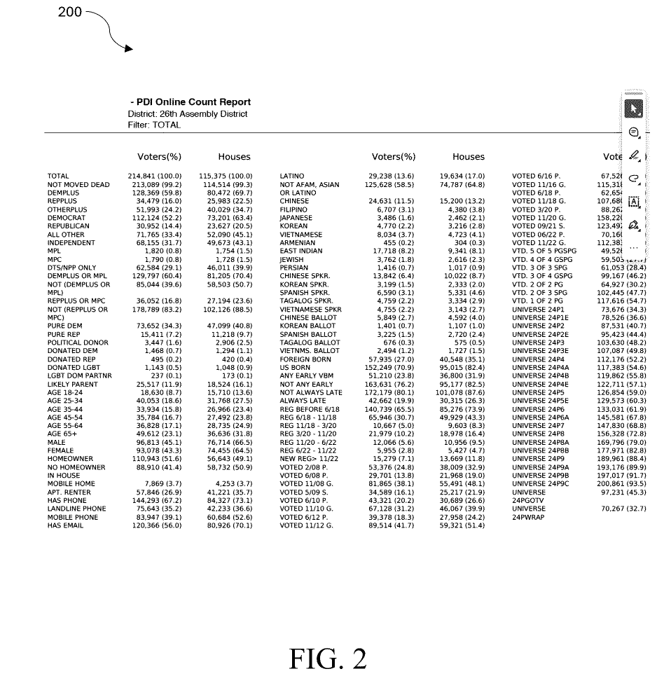

Referring now to FIG. 1, one exemplary method 100 for the application of data clustering algorithms to characterizing data and generating and transmitting generative AI messages to individuals associated with the characterizing data is shown and described in detail. At operation 102, one or more computing systems may receive characterizing data from one or more data stores. In some implementations, the characterizing data received may include information from a voter file. The voter file may include details of registered voters that may include information such as name, residence address, mailing address, precinct, voter history, registered political party, email, phone, voting history and the like. FIG. 2 illustrates exemplary characterizing data 200 that may be received at operation 102. A voter file may include information from an original voter file that has been augmented with derived information, augmented with additional outreach information, may have, for example, unreachable voters excluded or have other exclusions such as those determined to not likely vote, those of a certain political party, or other criteria such as prior political outreach efforts applied. These voter files may be compiled through a government agency such as the register of voters (ROV) or Secretary of State and the like.

The characterizing data may also include information about the candidates or measures themselves. See for example, the GUI 600 illustrated in FIG. 6. For example, information such as the candidate's age, gender, and nationality may be included with the characterizing data. A candidate may include a candidate for an elected office, or may include one or more of the following: (1) referenda which are measures referred by the legislature or government for voters to approve or reject; (2) bond measures in which voters may be asked to approve or reject government bonds for funding specific projects such as, and without limitation, infrastructure improvements or school construction; (3) recall elections where voters may decide whether to remove an elected official from office before their term is over; (4) advisory votes which are non-binding votes that gauge public opinion on specific issues; (5) judicial retention elections where voters decide whether certain judges should remain in office; (6) charter amendments which may be changes to a city or county charter, and which may serve as the local government's constitution; (7) special district elections in which voters may elect board members or approve measures related to specific local districts, such as water, fire, or school districts; and (8) party committee elections where voters select members of party committees at the local, state, or national levels. The characterizing data received at operation 102 may be limited to registered voters for a given candidate for an elected office and/or voting measure.

At operation 104, it may be determined whether the characterizing data received should be modified by augmenting and/or excluding the received characterizing data. If it is determined that characterizing data should be modified, and at operation 106, the characterizing data may be augmented and/or excluded. For example, additional outreach information could be augmented to the voter file and may include additional information such as email addresses, cell phone numbers, landline numbers, connected television (TV) addresses, social media identifiers, advertising identifiers, cookie information, and the like that may not be present in, for example, the original voter file. Characterizing data may also exclude unreachable voters as not all voters may be capable of receiving certain types of outreach. For example, a voter without an email address in the voter file (either with the original voter file or augmented voter file with additional outreach information) cannot receive political outreach via email messaging and may be excluded from the received characterizing data. As but another non-limiting example, those voters without a cell phone number (either with the original voter file or augmented voter file with additional outreach information) cannot receive political outreach via text messaging and may be excluded from the received characterizing data. On the other hand, those voters that can be reached are known as reachable voters.

The characterizing data received may also be augmented with so-called derived information or information that may be derived from the voter file. For example, information which may not exist in the voter file but can be computed or derived may include information such as nationality, marital status, gender, propensity to vote (e.g., propensity to vote score), political leaning score, type of phone, and the like. This derived information may also include demographic information such as census information that is not in the voter file. The augmented information may also include behavioral information. For example, if a voter has subscribed to certain publications (e.g., conservative or liberal publications), this information may be augmented to the characterizing data. Other publicly available information may be augmented as well such as, for example, if the voter purchased a car, the voter's home valuation, purchasing habits, type and number of pets at home, and the like. Moreover, using this augmented information, a later determination may be made to exclude characterizing data received such as based on, for example, wanting only to focus on certain types of voters based on this derived information or ability to reach by certain outreach methods.

At operation 108, clustering algorithms may be applied to the received characterizing data at operation 102 or may be applied to the augmented and/or excluded characterizing data from operation 106. As a brief aside, clustering is the task of grouping a set of objects in such a way that objects in the same group (called a cluster) are more similar (in some specific sense defined by the analyst) to each other than to those in other groups (i.e., other clusters). In other words, clustering techniques are machine learning algorithms that group together similar objects or data points into clusters based on their characteristics using statistical methods such as, for example, K-means or hierarchical clustering. For example, one such distinct cluster may result in Vietnamese Republican Homeowners, aged 55-65, who were born in the US, and have certain defined income levels.

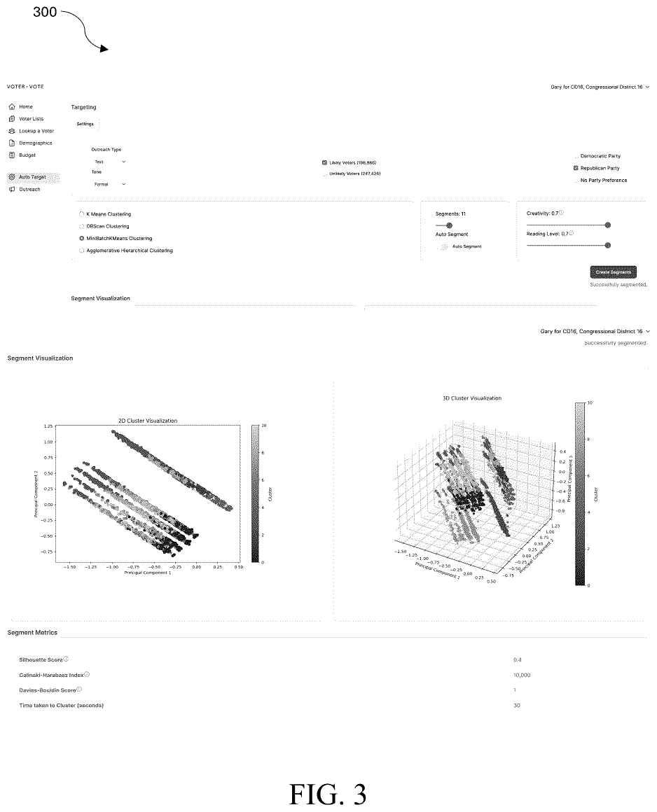

Referring now to FIG. 3, an exemplary GUI 300 for the application of clustering algorithms to the characterizing data is shown and described. As can be seen in FIG. 3, the GUI 300 enables a user to select between likely voters and unlikely voters. Additionally, the GUI 300 allows for the selection between: (1) the Democratic party; (2) the Republican party; and (3) a selection for no party preference. The GUI 300 may also allow for the selection between: (1) a K means clustering algorithm; (2) a DBScan clustering algorithm; (3) a MiniBatchKMeans clustering algorithm; and (4) an agglomerative hierarchical clustering algorithm. The use of these algorithms is well known and accordingly, an additional discussion of these algorithms is not provided herein. The GUI 300 also allows for the selection of the number of segments (or groups) the characterizing data should be segmented into. As shown in FIG. 3, the number of segments selected is eleven (11) although the number of segments can be more or fewer than eleven (11) in alternative implementations. A visualization of the clusters that were created during that application of, for example in this instance utilizing a MiniBatchKMeans clustering algorithm, is also illustrated in FIG. 3.

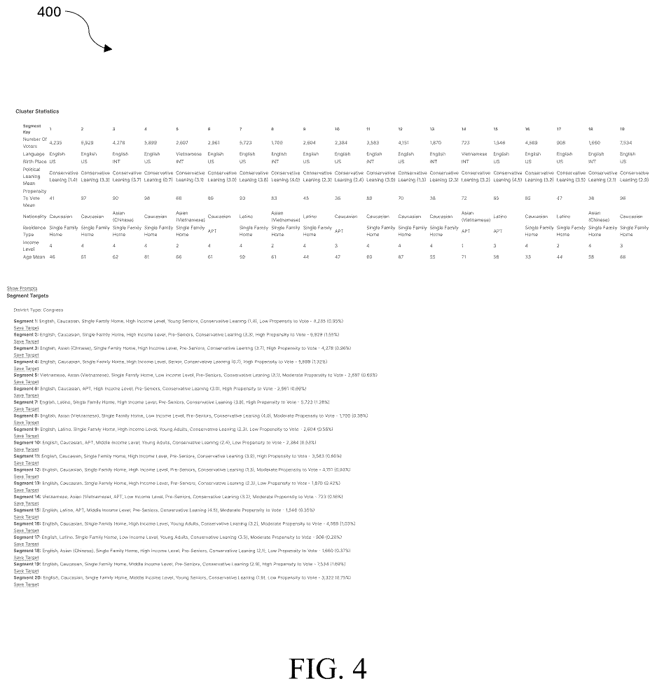

Returning to FIG. 1, and operation 110, the created clusters are parsed for metadata that provides a synopsis or overview of what characterizes each cluster. Referring now to FIG. 4, a GUI 400 represents the segments that were created at operation 108. Each segment (denoted by Segment Key followed by a number) is broken down into the following exemplary categories. Namely, and in this example, each segment is characterized by: (1) the number of voters within the segment; (2) the primary language spoken by the segment; (3) the birthplace of the segment (e.g., domestically or internationally); (4) the political leaning of the segment; (5) a calculated propensity to vote metric; (6) the nationality or ethnicity of the segment (e.g., Caucasian, Asian (including identified ethnicities or countries of origin), Latino, etc.); (7) residence type (e.g., single family homes, apartments, condos, etc.); (8) income levels; and (9) mean age for the segment. While the specific categorizations illustrated in FIG. 4 should merely be considered exemplary, it would be appreciated that other metadata associated with these segments may be parsed to add additional (or fewer) categories that classify the commonality between members in each of these individual segments.

Referring back to FIG. 1, at operation 112, this parsed metadata (or commonality between individual members of a given segment) is inserted into a generative AI engine for the creation of targeted messaging. As a brief aside, generative AI is a type of AI technology that creates new content by learning patterns from existing data. In other words, using advanced generative AI models, such as neural networks, this generative AI can generate text, images, music, videos, and other media that resemble human-made content that are specifically targeted at the parsed metadata classifications. For example, using generative AI methodologies, targeted political outreach messaging targets the specific concerns and preferences of individual voters or groups of voters. This messaging is specifically targeted or tailored to resonate with the unique concerns, values, and preferences of individual voters or distinct groups within the electorate. This type of outreach involves gathering insights about what matters most to each group, be it economic issues, environmental concerns, healthcare policies, or community development—and then crafting messages that address those priorities directly. By focusing on these individualized or group-based concerns, targeted outreach aims to build a deeper connection, demonstrate alignment with voters' values, and create a more meaningful dialogue that fosters voter engagement and loyalty. Additionally, by using generative AI technology to generate these messages, a nearly limitless number of messaging material with differing content may be created for each individual (or group of individuals) within a given cluster.

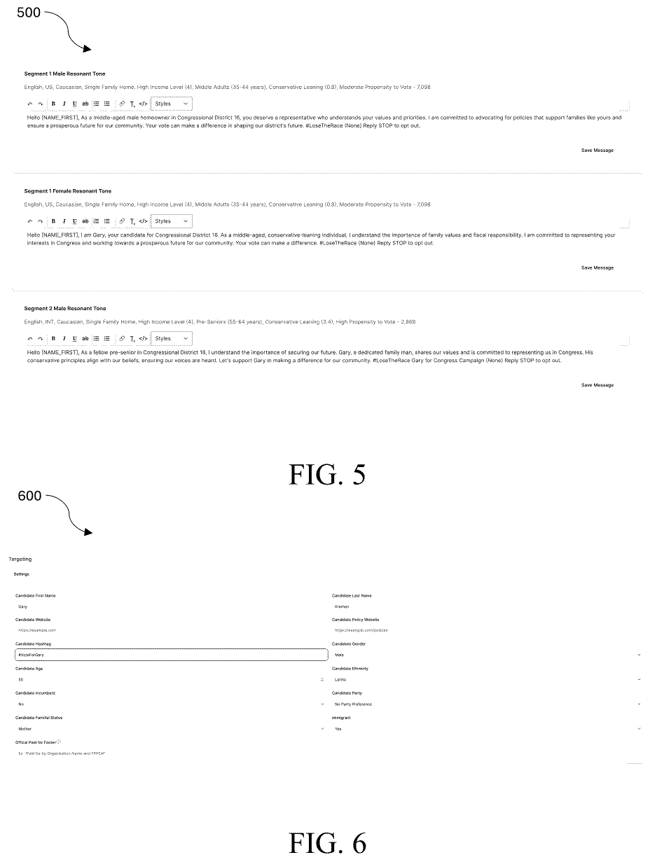

Referring now to FIG. 5, an exemplary GUI 500 illustrating generative AI messaging created using the parsed metadata from the created segments is shown. Specifically, three (3) exemplary messages are shown in FIG. 5, namely: (1) a male resonant tone for the first created segment; (2) a female resonant tone for the second created segment; and (3) a second male resonant tone for the third created segment. The parsed metadata associated with each of the created segments is displayed above the created message, and the generated messages created using the generative AI engine are shown for each of these created segments. In other words, generative AI messages are created that are designed to resonate with the characteristics of each distinct segmented voter group, therefore creating persuasive political messages tailored to the characteristics of each voter cluster.

Referring back to FIG. 1, at operation 114 the generative AI messages created at operation 112 are transmitted to individuals associated with the characterizing data for each of these created segments. These messages may be transmitted through various outreach channels including, for example, one or more of: email; short messaging service (SMS) (e.g., text messages); social media accounts; connected television accounts; streaming services; online display advertising; podcasts; push notifications; in-app messaging services; and print (e.g., through the postal service). These and other outreach channels would be readily apparent to one of ordinary skill, given the contents of the present disclosure. For example, and in the context of email messaging, these generative AI messages may differ from other ones of the generated AI messages such that these generative AI messages may bypass spam filters and/or other techniques which are designed to identify (and quarantine) unwanted messages. As a brief aside, a spam filter is a tool that analyzes incoming emails to identify and block unwanted, bulk, or potentially harmful messages. It may act as a barrier between users and unwanted emails, improving inbox cleanliness and reducing the risk of cyberattacks. Spam filters use various techniques to analyze emails, including sender reputation, content analysis, and machine learning, to determine if an email is likely spam.

In some implementations, prior to transmittal of these generated messages, the messages may be appended with additional information that allows the sender to gauge the effectiveness of the messaging. For example, and in the context of email, an address (or code) is inserted into the blind carbon copy (bcc) address of the email. This code may then be able to, for example, track whether the message had been read (or not read) for each recipient and report this information to, for example, the sender of these generative AI messages. In some implementations, this data regarding which messages have been read (or not read) may be utilized to further train and refine the generative AI algorithms for creation of more effective future messages.

### Exemplary Graphical User Interfaces (GUIs)

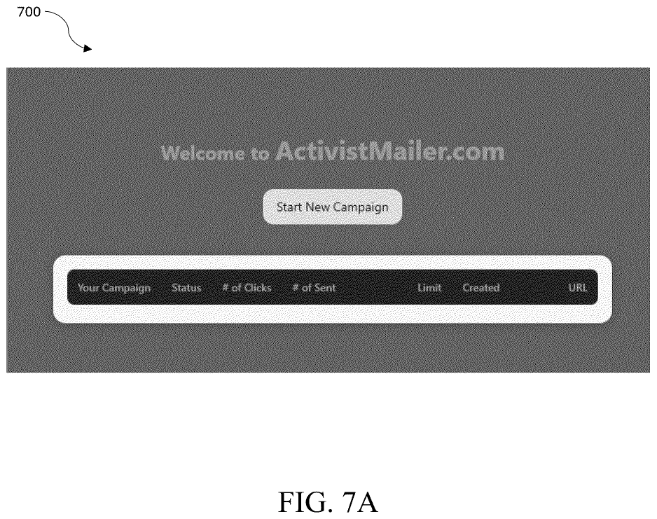

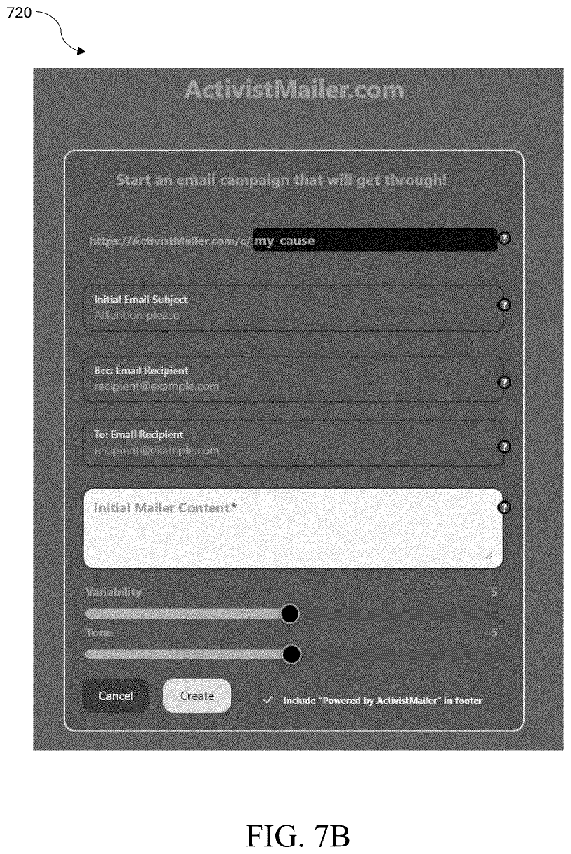

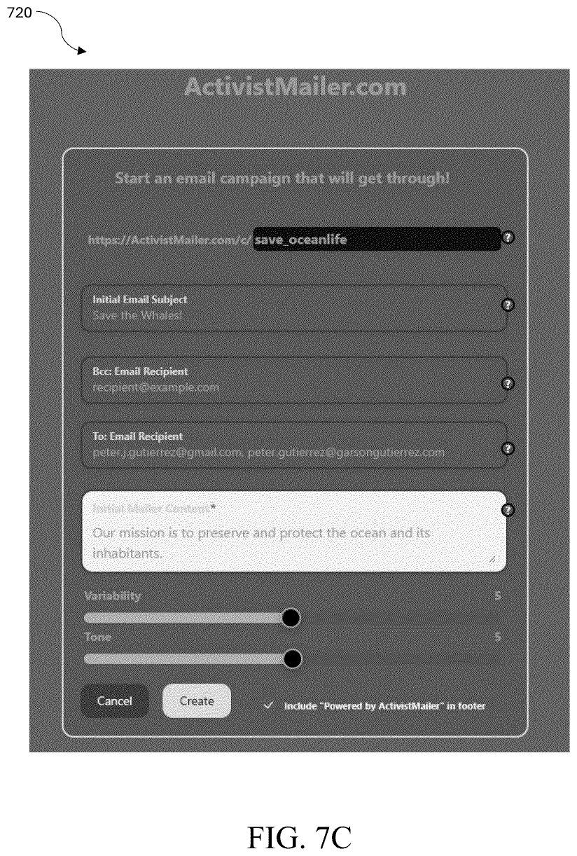

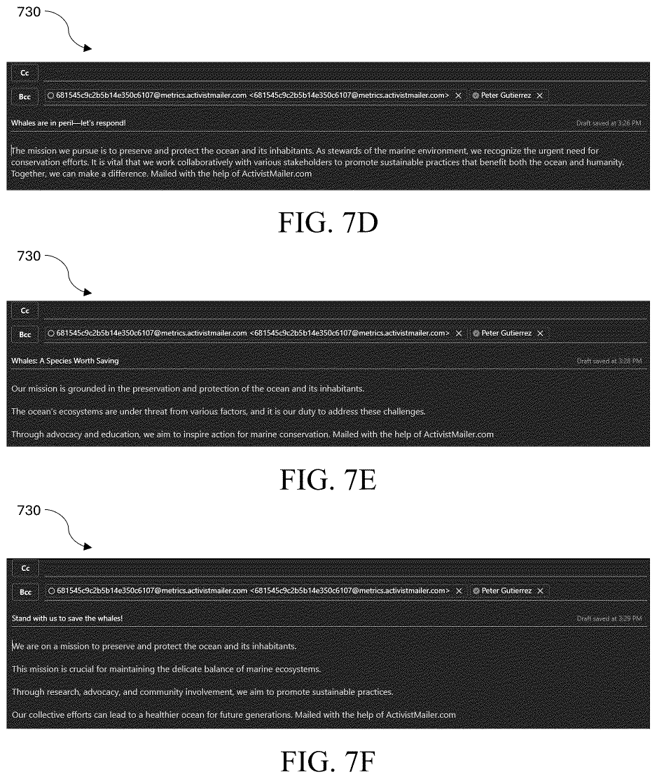

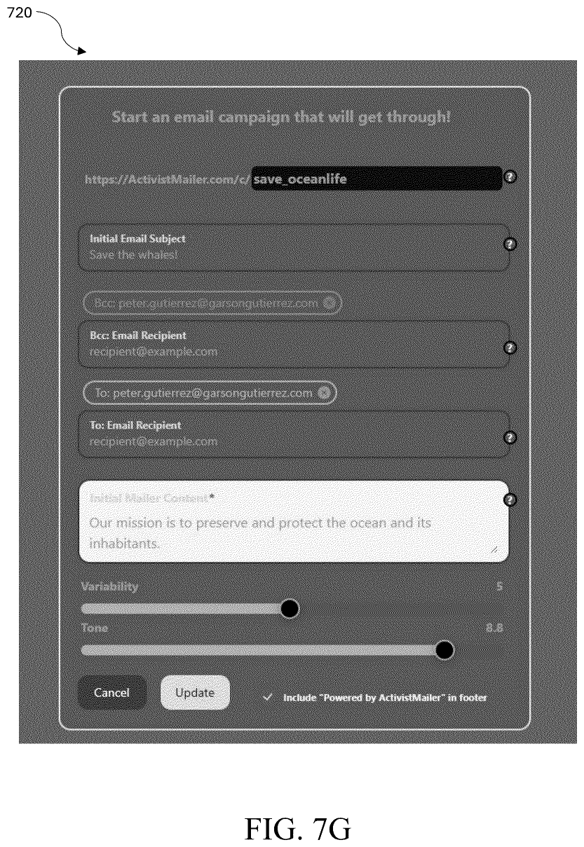

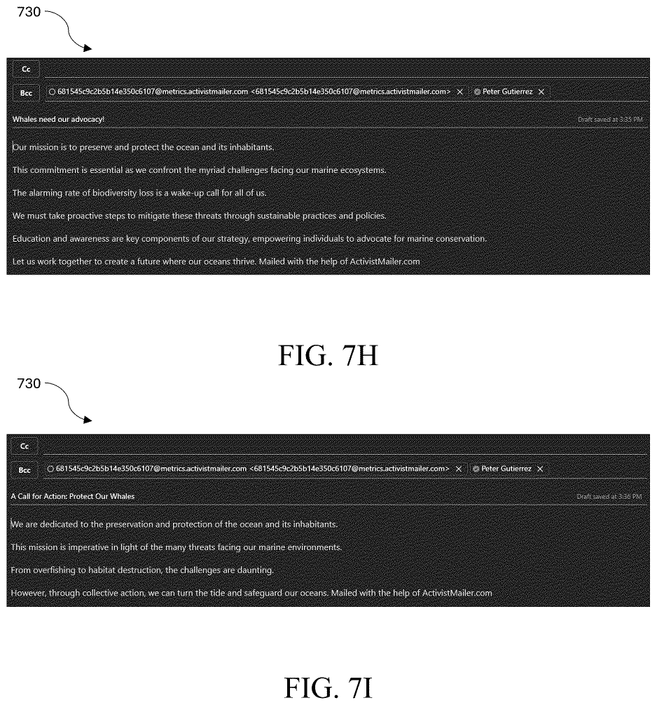

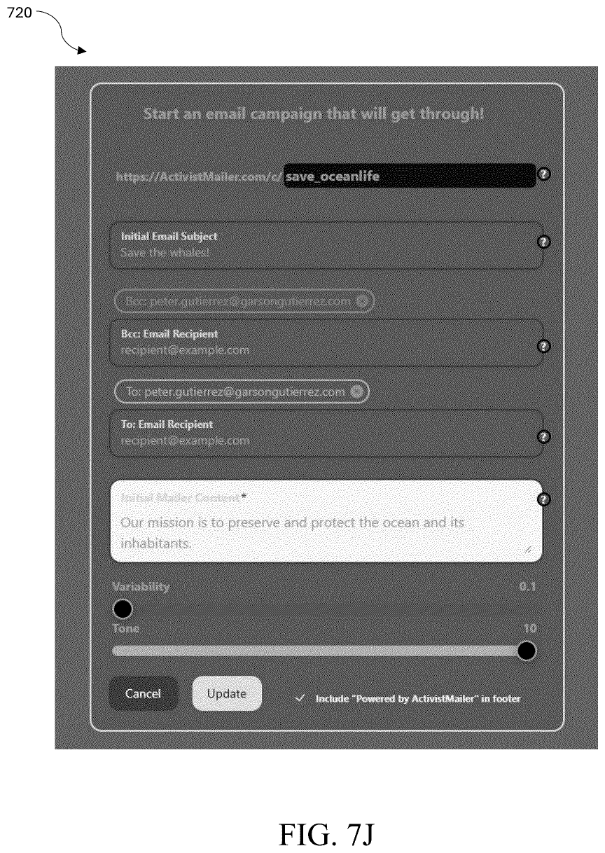

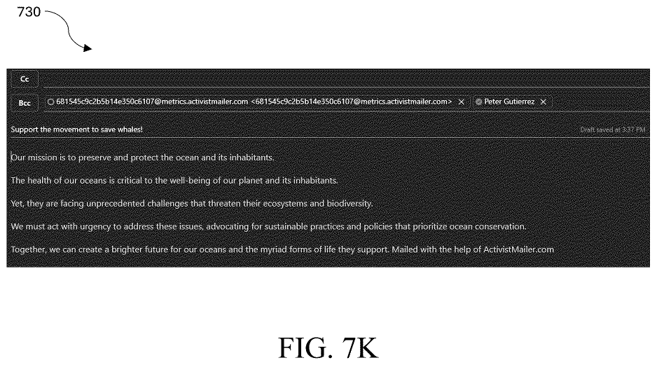

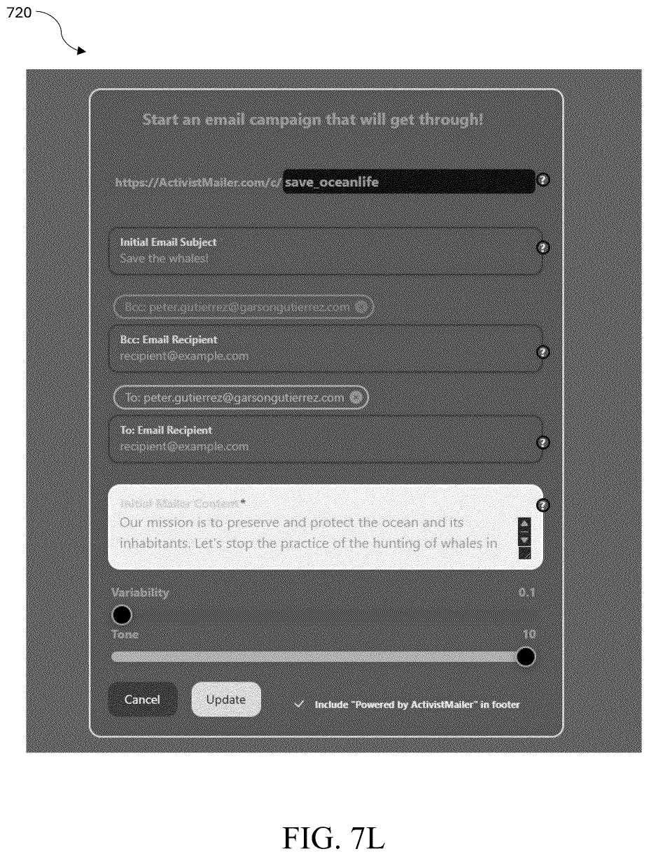

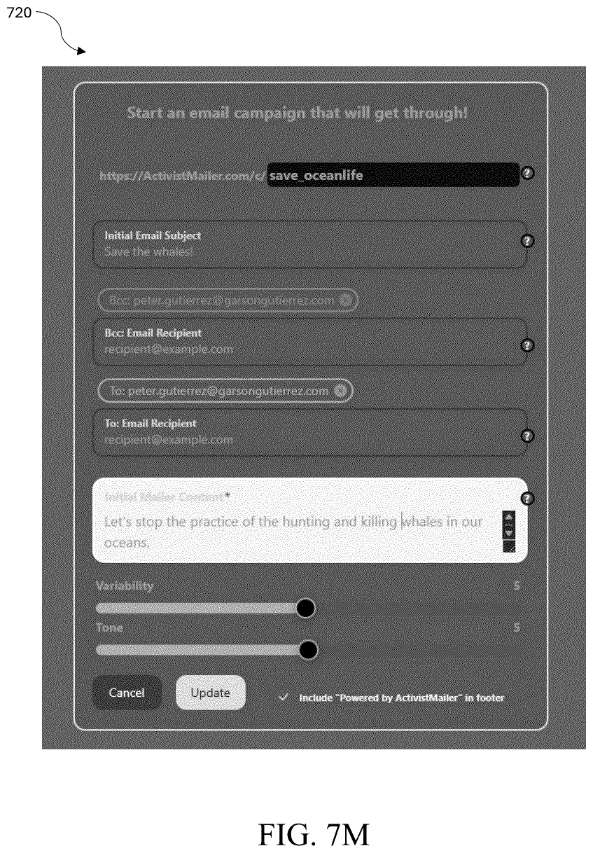

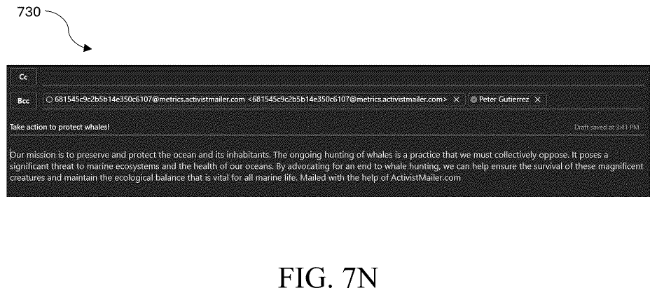

Referring now to FIG. 7A-7N, exemplary GUIs illustrating an exemplary implementation of the methodology of FIG. 1 is shown and described in detail. FIG. 7A illustrates an exemplary GUI 700 that summarizes various statistics surrounding your created campaign. For example, GUI 700 may include information about your created campaigns, the status of your created campaign, the number of times the messages you created for your campaign were opened, and the number of campaign communications that were sent. Upon the selection of the ‘Start New Campaign’ button, a user will be redirected to the GUI 720 illustrated in FIG. 7B.

Referring now to FIG. 7B, an exemplary GUI 720 is illustrated which enables a user to initiate the creation of a new campaign. The GUI 720 may include a field where a user may append a customizable uniform resource locator (URL) to a website that is hosting their cause. GUI 720 also includes a field that allows a user to insert an initial email subject line. The GUI 720 may also include a ‘to’ email recipient field entry along with a blind carbon copy (bcc) email recipient field. The GUI 720 also includes a data field that allows a user to type in their initial campaign content. The GUI 720 may also have both a variability and tone bar that enables a user to select between a value of 0.1 and a value of 10 for each of these bars. The GUI 720 also provides a button that enables the messages to be created.

Referring now to FIG. 7C, an exemplary campaign has now been entered into the GUI 720. Specifically, the customizable URL has been appended with the phrase ‘save_ocreanlife’, and the initial email subject has been introduced as ‘Save the Whales!’. In the initial mailer content, the phrase ‘Our mission is to preserve and protect the ocean and its inhabitants’. The variability and tone bars have been selected to a value of 5. After a user selects the create button, FIG. 7D-7F illustrate various messages that have now been created using the prompts entered in FIG. 7C. For example, the GUI 730 illustrated in FIG. 7D has changed the initial subject line ‘Save the Whales!’ to ‘Whales are in peril-let's respond!’. The messaging created states: ‘The mission we pursue is to preserve and protect the ocean and its inhabitants. As stewards of the marine environment, we recognize the urgent need for conservation efforts. It is vital that we work collaboratively with various stakeholders to promote sustainable practices that benefit both the ocean and humanity. Together, we can make a difference. Mailed with the help of ActivistMailer.com’.

FIG. 7E illustrates another message that was created using the same settings in FIG. 7C to demonstrate the variability in the messaging content. For example, the GUI 730 illustrated in FIG. 7E has changed the initial subject line ‘Save the Whales!’ to ‘Whales: A Species Worth Saving’. The messaging created states: ‘Our mission is grounded in the preservation and protection of the ocean and its inhabitants. The ocean's ecosystems are under threat from various factors, and it is our duty to address these challenges. Through advocacy and education, we aim to inspire action for marine conservation. Mailed with the help of ActivistMailer.com’.

FIG. 7F illustrates yet another message that was created using the same settings in FIG. 7C to again demonstrate the variability in the messaging content. For example, the GUI 730 illustrated in FIG. 7F has changed the initial subject line ‘Save the Whales!’ to ‘Stand with us to save the whales!’. The messaging created states: ‘We are on a mission to preserve and protect the ocean and its inhabitants. This mission is crucial for maintaining the delicate balance of marine ecosystems. Through research, advocacy, and community involvement, we aim to promote sustainable practices. Our collective efforts can lead to a healthier ocean for future generations. Mailed with the help of ActivistMailer.com’.

Referring now to FIG. 7G, the GUI 720 is identical to the GUI illustrated in FIG. 7C; however, the tone has now been changed from 5 to 8.8. FIGS. 7H and 7I illustrate exemplary messaging GUIs 730 created using this updated tone setting. For example, the GUI 730 illustrated in FIG. 7H has changed the initial subject line ‘Save the Whales!’ to ‘Whales need our advocacy!’. The messaging created states: ‘Our mission is to preserve and protect the ocean and its inhabitants. This commitment is essential as we confront the myriad challenges facing our marine ecosystems. The alarming rate of biodiversity loss is a wake-up call for all of us. We must take proactive steps to mitigate these threats through sustainable practices and policies. Education and awareness are key components of our strategy, empowering individuals to advocate for marine conversation. Let us work together to create a future where our oceans thrive. Mailed with the help of ActivistMailer.com’.

FIG. 7I illustrates another message that was created using the same settings in FIG. 7G to again demonstrate the variability in the messaging content. For example, the GUI 730 illustrated in FIG. 7I has changed the initial subject line ‘Save the Whales!’ to ‘A Call for Action: Protect Our Whales’. The messaging created states: ‘We are dedicated to the preservation and protection of the ocean and its inhabitants. This mission is imperative in light of the many threats facing our marine environments. From overfishing to habitat destruction, the challenges are daunting. However, through collective action, we can turn the tide and safeguard our oceans. Mailed with the help of ActivistMailer.com’.

Referring now to FIG. 7J, the GUI 720 is again identical to the GUI illustrated in FIG. 7C; however, the tone has now been changed from 5 to 10 and the variability has changed from 5 to 0.1. FIG. 7K illustrates an exemplary messaging GUI 730 created using this updated tone and variability setting. For example, the GUI 730 illustrated in FIG. 7K has changed the initial subject line ‘Save the Whales!’ to ‘Support the movement to save whales!’. The messaging created states: ‘Our mission is to preserve and protect the ocean and its inhabitants. The health of our oceans is critical to the well-being of our planet and its inhabitants. Yet, they are facing unprecedented challenges that threaten their ecosystems and biodiversity. We must act with urgency to address these issues, advocating for sustainable practices and policies that prioritize ocean conservation. Together, we can create a brighter future for our oceans and the myriad forms of life they support. Mailed with the help of ActivistMailer.com’.

FIG. 7L illustrates that the initial mailer content can also be adjusted in the GUI 720. Here the messaging has been appended with additional content that states: ‘Let's stop the practice of the hunting and killing of whales in our oceans.’ FIG. 7M illustrates the update of the initial mailer content to remove the phrase: ‘Our mission is to preserve and protect the ocean and its inhabitants.’ FIG. 7N illustrates an exemplary messaging GUI 730 created using the content illustrated in FIG. 7M. Specifically, the GUI 730 illustrated in FIG. 7N has changed the initial subject line ‘Save the Whales!’ to ‘Take action to proect whales!’. The messaging created states: ‘Our mission is to preserve and protect the ocean and its inhabitants. The ongoing hunting of whales is a practice that we must collectively oppose. It poses a significant threat to marine ecosystems and the health of our oceans. By advocating for an end to whale hunting, we can help ensure the survival of these magnificent creatures and maintain the ecological balance that is vital for all marine life. Mailed with the help of ActivistMailer.com’.

### Computing Systems

The functionality of the methodologies described herein may be implemented through the use of software executed by one or more processors (or controllers) and/or may be executed via the use of one or more dedicated hardware modules, with the architecture of the system being optimized to execute the data clustering and generative AI methodologies discussed herein. The computer code (software) disclosed herein is intended to be executed by a computing system that reads instructions from a non-transitory computer-readable medium and executes them in one or more processors (or controllers), whether off-the-shelf or custom manufactured. The computing system may be used to execute instructions (e.g., program code or software) for causing the computing system to execute the computer code described herein. In some implementations, the computing system operates as a standalone device or a connected (e.g., networked) device that connects to other computing systems. The computing system may include, for example, a personal computer (PC), a tablet PC, a notebook computer, or other custom device capable of executing instructions (sequential or otherwise) that specify actions to be taken. In some implementations, the computing system may include a server. In a networked deployment, the computing system may operate in the capacity of a server or client in a server-client network environment, or as a peer device in a peer-to-peer (or distributed) network environment. Moreover, a plurality of computing systems may operate to jointly execute instructions to perform any one or more portions of the methodologies discussed herein.

An exemplary computing system includes one or more processing units (generally processor apparatus). The processor apparatus may include, for example, a central processing unit (CPU), a graphics processing unit (GPU), a digital signal processor (DSP), a controller, a state machine, one or more application specific integrated circuits (ASICs), one or more radio-frequency integrated circuits (RFICs), or any combination of the foregoing. The computing system also includes a main memory. The computing system may include a storage unit. The processor, memory and the storage unit may communicate via a bus.

In addition, the computing system may include a static memory, a display driver (e.g., to drive a plasma display panel (PDP), a liquid crystal display (LCD), a projector, or other types of displays). The computing system may also include input/output devices, e.g., an alphanumeric input device (e.g., touch screen-based keypad or an external input device such as a keyboard), a dimensional (e.g., 2-D or 3-D) control device (e.g., a touch screen or external input device such as a mouse, a trackball, a joystick, a motion sensor, or other pointing instrument), a signal capture/generation device (e.g., a speaker, camera, and/or microphone), and a network interface device, which may also be configured to communicate via, for example, a computer bus.

Embodiments of the computing system corresponding to a client device may include a different configuration than an embodiment of the computing system corresponding to a server. For example, an embodiment corresponding to a server may include a larger storage unit, more memory, and a faster processor but may lack the display driver, input device, and dimensional control device. An embodiment corresponding to a client device (e.g., a personal computer (PC)) may include a smaller storage unit, less memory, and a more power efficient (and slower) processor than its server counterpart(s).

The storage unit includes a non-transitory computer-readable medium on which is stored instructions (e.g., software) embodying any one or more of the methodologies or functions described herein. The instructions may also reside, completely or at least partially, within the main memory or within the processor (e.g., within a processor's cache memory) during execution thereof by the computing system, the main memory and the processor also constituting non-transitory computer-readable media. The instructions may be transmitted or received over a network via the network interface device.

While non-transitory computer-readable medium is shown in an example embodiment to be a single medium, the term “non-transitory computer-readable medium” should be taken to include a single medium or multiple media (e.g., a centralized or distributed database, or associated caches and servers) able to store the instructions. The term “non-transitory computer-readable medium” shall also be taken to include any medium that is capable of storing instructions for execution by the computing system and that cause the computing system to perform, for example, one or more of the methodologies disclosed herein.

In some implementations, a system for targeted outreach comprises a plurality of interconnected modules implemented by one or more servers or other computing devices. A data ingestion module is configured to retrieve characterizing data from one or more data stores, normalize the data into feature vectors, and store the feature vectors in a feature store. An augmentation and exclusion module is configured to augment the feature vectors with derived attributes and reachability vectors and to exclude feature vectors that do not satisfy reachability or other campaign criteria.

A clustering engine is configured to apply one or more unsupervised clustering algorithms to the feature vectors and to assign cluster identifiers to the feature vectors. A metadata computation module is configured to compute cluster metadata objects for each cluster and to store the metadata objects in a metadata store. A campaign context module is configured to construct extended campaign context objects that combine respective cluster metadata objects with position descriptors associated with one or more candidates, ballot measures, or other political or issue-based propositions. A prompt-compiler module is configured to construct, for each cluster or combination of cluster and campaign objective, one or more generative-AI input structures, such as prompts, based on the corresponding extended campaign context object, campaign attributes, and tone and variability parameters.

A generative content module is configured to provide the input structures to one or more generative models and to receive generated content, such as text, image, or video content, that may serve as first-stage messages. One or more downstream pipeline-processing modules are configured to receive the first-stage messages and to perform further processing, such as rewriting, channel-specific formatting, classification, or scoring, to generate second-stage messages that are suitable for transmission. A diversification module may enforce a minimum dissimilarity threshold that depends on a chosen value. Candidate messages that are too similar may be discarded or replaced, ensuring that the set of approved messages for a cluster satisfies a targeted variability level while still being aligned with the cluster metadata and campaign objectives. A predictive scoring module is configured to compute predicted performance metrics for candidate cluster-message-channel combinations. An outreach orchestration module is configured to select one or more combinations based on the predicted performance metrics and to provide the selected combinations to a plurality of outreach channel adapters. Each outreach channel adapter is configured to transform generated content and addressing information into a format appropriate for a corresponding communication channel and to initiate transmission via that channel.

In some embodiments, one or more of the foregoing modules may be combined, divided, replicated, or omitted. The modules may be implemented as software components executing on general-purpose servers, as virtualized services in a cloud computing environment, or as specialized hardware modules. In some embodiments, the system may be deployed in a multi-tenant environment in which different campaigns, clients, or organizations are isolated from one another at the data and configuration levels.

### Exemplary Clustering and Generative AI Implementations

In various implementations, the systems and methods described herein provide improvements to the operation of computer systems that process large-scale characterizing data and generate outreach content. For example, an exemplary clustering pipeline transforms heterogeneous records (e.g., the characterizing data from a population of individuals) from one or more data stores into normalized feature vectors. As a brief aside, a normalized feature vector is a vector where each feature is scaled to a standardized range (e.g., between zero and one, between negative one and one, etc.) to ensure all features within the characterizing data contribute more equally and prevent large-valued features from dominating the clustering algorithms being utilized. This normalization may utilize mathematical transformations such as, for example, Min-Max normalization, Z-score standardization, vector magnitude normalization, and the like. These normalized feature vectors are then used to compute unsupervised clusters in a high-dimensional feature space, and derive compact cluster metadata objects that are not present in the original records. These metadata objects are subsequently used as parameterized inputs to one or more generative artificial intelligence models, thereby reducing the number of model invocations, reducing overall bandwidth and compute requirements, and enabling consistent control over the properties of generated content across large populations of diverse individuals.

Unsupervised clustering algorithms are utilized to find hidden patterns and/or natural groupings in unlabeled data, without prior knowledge of the categories or labels that are ultimately determined. These unsupervised clustering algorithms may utilize partitioning-based methodologies such as K-means clustering, or K-medoid clustering techniques. K-means clustering partitions data into a user-defined number of clusters by iteratively assigning data points to the nearest cluster centroid and then recalculating the centroid. K-medoid clustering is similar to K-means clustering. However, K-medoid algorithms use actual data points (i.e., medoids) as the cluster centers, which can be more robust to outlier data than using the K-means methodology.

These unsupervised clustering algorithms may also use hierarchical-based methodologies such as agglomerative clustering, or divisive clustering. Agglomerative clustering starts with each data point as an individual cluster and iteratively merges the closest pairs of clusters until one or more larger clusters remain. Divisive clustering, in contrast to agglomerative clustering, starts with all data in a single cluster and recursively splits the single cluster into multiple clusters.

These unsupervised clustering algorithms may also use density-based methodologies such as the aforementioned DBSCAN or ordering points to identify the clustering structure (OPTICS). DBSCAN clustering algorithms group together data points that are closely packed together in the feature space while marking points that lie in lower-density regions as noise. OPTICS may be considered a variation of DBSCAN that produces a plot to represent the density-based clustering structure of the data, without explicitly producing the clusters themselves. In some implementations, combinations of the aforementioned clustering algorithms may be utilized sequentially to, for example, further refine the clustering of the data, or in parallel to determine which clustering algorithm is ultimately more successful in clustering the data set into more effective targeted messages.

In some implementations, and subsequent to the application of the one or more clustering algorithms, cluster metadata objects may be computed. For example, a cluster metadata object may include, for the members of a cluster, one or more of: (i) counts or percentages for categorical attributes; (ii) means or medians for numerical attributes; (iii) dispersion or concentration metrics; (iv) entropy or divergence measures relative to a reference population; and (v) derived attributes such as a primary language, a dominant issue category, a dominant outreach channel, or a dominant demographic characteristic.

In contrast to platforms that rely primarily on manual copywriting or static message templates to target segments of voters or customers, embodiments of the disclosed system integrate a specific sequence of technical operations, including: ingestion and normalization of characterizing data, augmentation and optional exclusion based on reachability vectors, unsupervised clustering, algorithmic extraction of cluster metadata objects, compilation of structured prompts or other model inputs, controlled generative content creation, optional predictive scoring of cluster-message-channel combinations, and automated transmission through one or more outreach channel adapters. This integrated pipeline yields improved computer functionality by, for example, decreasing redundant data storage, enabling cache reuse of cluster metadata and prompts, and constraining generative operations to those combinations that a predictive model determines are likely to achieve a target engagement metric.

In some implementations, the messages generated by the generative artificial intelligence models are treated as intermediate representations that may undergo further pipeline processing prior to transmission. For example, a campaign context module may construct an extended campaign context object that combines the cluster metadata object with position descriptors associated with one or more candidates, ballot measures, or other political or issue-based propositions. The extended campaign context object is supplied to a generative-AI prompt template to produce a first-stage message for each cluster. The first-stage messages can then be provided to one or more downstream processing modules, such as rewriting modules, channel-adaptation modules, and scoring or classification models, which further refine, adapt, or evaluate the messages before they are delivered to individual recipients. Treating generative outputs as intermediate artifacts in a multi-stage pipeline enables finer-grained control over message content and format while still leveraging cluster-specific metadata and position information.

### Comparison with Conventional Approaches

The following discussion of certain existing approaches is provided for general background and context only and does not constitute an admission that any such approaches are prior art to the present disclosure. Various known systems use data-driven techniques to personalize digital content. For example, some messaging platforms retrieve data about an individual user or organization from a knowledge graph or other structured store and generate a personalized message by inserting pieces of that data into a message template or directed content structure. Other systems generate digital marketing content and select small segments of consumers for the content based on historical response data and propensity scores. Commercial political analytics and voter-data products can integrate voter files, provide machine-learning based audience segments, and inform human-written campaign messaging for particular channels.

While these approaches can personalize content or support microtargeting, they typically: (i) operate at the level of individual records or pre-defined audience segments rather than constructing explicit cluster metadata objects with aggregated statistics for each cluster; (ii) do not expose cluster metadata objects as structured inputs to a generative artificial intelligence model; (iii) do not provide a coordinated mechanism for jointly controlling generative model behavior using tone and variability parameters that are mapped from user interface controls into model-control parameters and diversity thresholds; (iv) do not integrate, in a single coherent pipeline, unsupervised clustering on voter-registration-style characterizing data, metadata extraction, prompt compilation, generative content creation, predictive scoring of cluster-message-channel combinations, and automatic transmission of the resulting outreach messages through multiple communication channels; and (v) do not treat generative outputs as intermediate representations that can be further processed by downstream pipeline modules prior to delivery.

By contrast, in one implementation of the present disclosure, registered-voter records from one or more government-maintained voter-registration data stores are normalized into high-dimensional feature vectors, clustered using an unsupervised clustering algorithm, and summarized into cluster metadata objects that include distributions over attributes such as party affiliation, turnout history, language, and income bands. These cluster metadata objects, together with extended campaign context data that includes candidate, ballot-measure, or other position descriptors, are inserted into generative-AI prompt templates along with tone and variability parameters derived from user interface controls. A generative model uses these inputs to generate a plurality of first-stage outreach messages per cluster. The first-stage outreach messages may then be provided as inputs to one or more downstream pipeline-processing modules that further refine, adapt, or evaluate the messages for particular channels or objectives. The system therefore combines unsupervised clustering, structured metadata construction, controlled generative content creation, multi-stage pipeline processing, predictive scoring, and multi-channel transmission in a manner that is specifically adapted to voter file data and political or issue-based outreach, thereby providing a technical solution to the problem of efficiently generating and delivering large volumes of differentiated, cluster-specific outreach content.

### Tone and Variability Parameters

In some implementations, a user interface includes controls that allow a campaign operator to specify a desired tone and/or variability for messages to be generated for a given cluster or campaign. For example, a tone slider may accept values on a numerical scale (e.g., 0.1 to 10.0) that a tone-mapping module converts into a tone parameter τ. The tone parameter τ may be used to select, from a library of generative-AI prompt templates, a template characterized by a particular style (e.g., neutral, urgent, or conversational), to select a target reading level, and/or to set one or more constraints on message length or directness.

In some variants, the variability slider similarly accepts values that are converted into a variability parameter ν. The variability parameter ν is provided to the generative model and/or diversification module. The variability parameter ν may, for example, be mapped to a sampling temperature, a nucleus sampling probability threshold, or a constraint on the maximum similarity between vector embeddings of different generated messages for the same cluster. As ν is increased, the system may allow greater diversity across generated messages for the same cluster; as ν is decreased, the system may constrain generated messages to be more similar to one another.

In some implementations, the system generates multiple candidate messages for a cluster and computes pairwise similarity scores between message representations (e.g., embedding-based similarities). For example, each of the candidate messages may be processed into a large language model (LLM) vector embedding which converts words, phrases and/or sentences into a multi-dimensional vector space. The similarity scores between these LLM vector embeddings may then be computed (e.g., using cosine similarity functions, etc.) and compared against a predefined threshold. A diversification module enforces a minimum dissimilarity threshold that depends on ν. Candidate messages that are too similar may be discarded or replaced, ensuring that the set of approved messages for a cluster satisfies a targeted variability level while still being aligned with the cluster metadata and campaign objectives.

### Predictive Scoring and Selection of Outreach Combinations

In some implementations, the system includes a predictive scoring module that selects among multiple possible cluster-message-channel combinations based on predicted performance. The predictive scoring module may be implemented as a supervised machine learning model, such as a logistic regression model, gradient boosted decision tree model, neural network, or other classifier or regressor.

For a given cluster, campaign objective, and candidate message, the predictive scoring module constructs a feature vector that may include one or more elements from the cluster metadata object (e.g., language distribution, average turnout score, age distribution), campaign attributes (e.g., office sought, partisan alignment, election date), channel attributes (e.g., email versus SMS versus connected television), and numerical encodings of message properties (e.g., length, tone parameter, variability parameter, or embedding-derived features). The predictive scoring model outputs a predicted engagement metric, such as an open rate, click-through rate, donation probability, or probability of response.

The system may use the predicted engagement metrics to select, for each cluster, one or more messages and channels whose predicted metrics exceed a threshold or maximize an objective function subject to constraints (e.g., budget or frequency caps). By using the predictive scoring module in this manner, the system avoids transmitting messages that are predicted to perform poorly, thereby reducing network and compute usage and improving the overall efficiency of the outreach pipeline.

### Multilingual and Multimodal Outreach

In some implementations, the cluster metadata objects include language-related attributes that reflect the distribution of preferred or primary languages for individuals in the cluster. A language selection module may determine a target language for a cluster based on these attributes and a campaign policy, such as selecting a single primary language, generating multiple language variants, or generating bilingual messages.

The prompt-compiler module may insert an indication of the selected language into the generative-AI prompt template and may also specify a target reading level or register appropriate to the cluster. For clusters that include significant fractions of speakers of distinct languages, the system may generate separate messages or campaigns for each language and may annotate the reachability vectors at the individual level to ensure that each individual receives content in a suitable language.

In addition to text-based messages, the system may generate or cause to be generated associated image or video content conditioned on the same cluster metadata. For example, a text-to-image or text-to-video generative model may receive prompts that include references to local landmarks, issues, or communities that are characteristic of the cluster, thereby producing visuals that are more likely to resonate with the cluster. The resulting images or videos may be associated with the generated textual messages and transmitted through outreach channel adapters that support visual content, such as social media platforms, connected television, online display advertising networks, or messaging applications.

It will be recognized that while certain aspects of the present disclosure are described in terms of specific design examples, these descriptions are only illustrative of the broader methods of the disclosure and may be modified as required by the particular design. Certain steps may be rendered unnecessary or optional under certain circumstances. Additionally, certain steps or functionality may be added to the disclosed embodiments, or the order of performance of two or more steps permuted. All such variations are considered to be encompassed within the present disclosure described and claimed herein.

While the above detailed description has shown, described, and pointed out novel features of the present disclosure as applied to various embodiments, it will be understood that various omissions, substitutions, and changes in the form and details of the device or process illustrated may be made by those skilled in the art without departing from the principles of the present disclosure. The foregoing description is of the best mode presently contemplated of carrying out the present disclosure. This description is in no way meant to be limiting, but rather should be taken as illustrative of the general principles of the present disclosure. The scope of the present disclosure should be determined with reference to the claims.

1. A computer-implemented method for creating and transmitting targeted outreach messaging, comprising:
receiving characterizing data associated with a plurality of individuals from one or more data stores;
normalizing the characterizing data into feature vectors in an n-dimensional feature space;
applying at least one clustering algorithm to the feature vectors to generate a plurality of clusters, each cluster comprising feature vectors for a subset of the plurality of individuals;
for each of the plurality of clusters, computing a cluster metadata object comprising one or more aggregated statistics derived from the characterizing data of individuals in the cluster;
for each of the plurality of clusters, generating a generative-artificial-intelligence (AI) input structure by inserting at least a portion of the corresponding cluster metadata object and campaign context data into a generative-AI prompt template, wherein the generative-AI input structure further comprises a tone parameter and a variability parameter;
providing the generative-AI input structure to a generative AI model to obtain at least one outreach message for the corresponding cluster;
for each of the plurality of individuals, selecting at least one communication channel based on a reachability vector associated with that individual; and
transmitting, via one or more outreach channel adapters configured for the selected communication channel or channels, the outreach messages to the individuals associated with the corresponding clusters.
